(19) United States
(12) Patent Application Publication
(10) Pub. No.: US 2004/0008478 A1
(43) Pub. Date: Jan. 15, 2004

(54) Sideboard of computer enclosure

(76) Inventor: Deng-Hsi Chen, Keelung (TW)

Correspondence Address: BIRCH STEWART KOLASCH & BIRCH, PO BOX 747, FALLS CHURCH, VA, 22040-0747, US

(21) Appl. No.: 10/192,643

(22) Filed: Jul. 11, 2002

(51) Int. Cl. G06F 1/16

(52) U.S. Cl. 361/683; 312/223.2

(57) ABSTRACT

A computer enclosure includes a frame with several fasteners and inlaid plates on one side, an open window is on the frame, a transparent plate is installed on one side of the open window, users or repair technicians can see the internal devices from outside directly.

### BACKGROUND OF THE INVENTION

I. Field of the Invention

This invention relates generally to a sideboard of a computer enclosure and, more specifically, to a sideboard of a computer enclosure that has a frame with several fasteners and inlaid plates on one side, an open window is on the frame, a transparent plate is installed on one side of the open window, users or repair technicians can see the internal devices from outside directly.

II. Description of the Prior Art

Heretofore, it is known that personal computers are very popular, many of peripheral devices and add-on cards with different functions are also available; therefore to increase or replace peripheral devices is very common for a personal computer. However to a none expert PC end user, he or she might not understand PC or know what is inside the PC. Once there is any problem with the PC, a professional or expert is needed to repair or fix; however the professional might not realize what is the problem right away, most of them would open the PC enclosure first to see the internal devices and part numbers, then check weather those devices function properly or not, or any strange sound in particular location. While opening the computer case, the screws and parts have to be placed in front of the computer desk that has limited space, this condition might causes tedious or even mistaken actions.

### SUMMARY OF THE INVENTION

It is therefore a primary object of the invention to provide a sideboard of a computer enclosure comprising a frame with fasteners and inlaid plates on the edges of four sides to insert the fame firmly to a computer enclosure; an open window in proper size is on the frame, users can see the internal device condition clearly through the transparent plate for repairing and recording first to take or purchase the replacement, or move the computer to a proper location to disassemble, repair or replace and take care of the problem once disassemble not to disassemble and assemble the computer in the limited space repeatedly.

It is another objective of this invention to provide a sideboard of a computer enclosure to have a shielding plate fixed on the inner side of the frame by several sealers on the transparent plate; in certain circumstances, the shielding plate can hide the internal devices for security purpose.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an explosive view of the present invention;

FIG. 2 is an assembling view of the present invention;

FIG. 3 is a cross-sectional view of an embodiment of the present invention;

FIG. 4 is a cross-sectional view of another embodiment of the present invention;

FIG. 5 is a perspective view of an embodiment of the present invention.

### DESCRIPTION OF THE PREFERRED EMBODIMENT

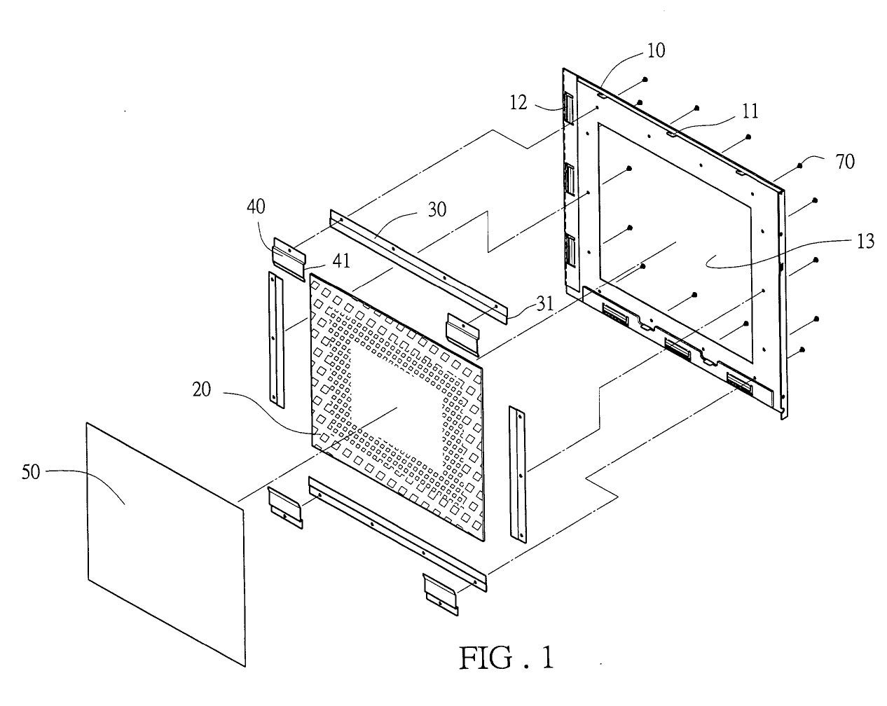

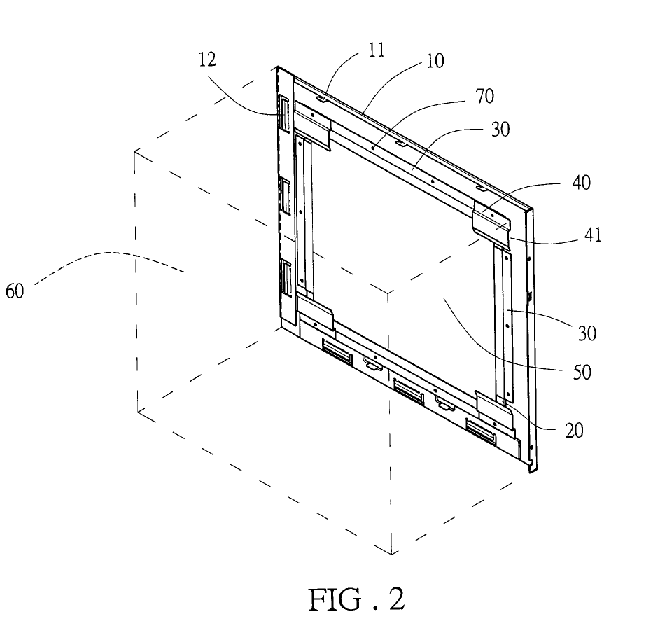

Referring to FIG. 1 and FIG. 2, the present invention is composed of a frame (10) with fastener (11) and inlaid plate (12) on the edges of four sides to insert the fame (10) firmly to a computer enclosure (60); an open window (13) in proper size is on the frame (10).

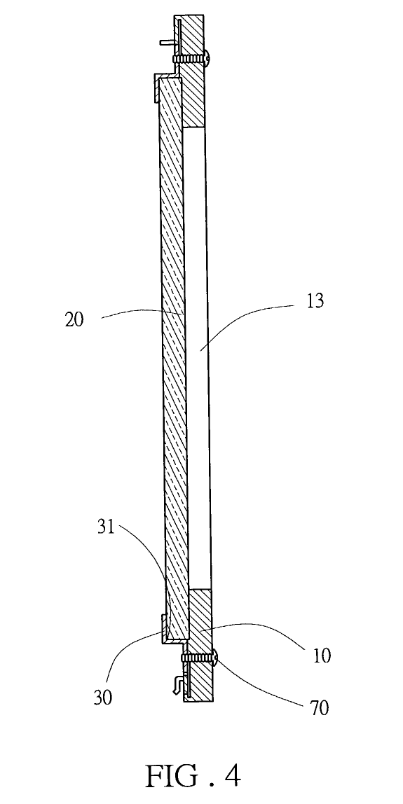

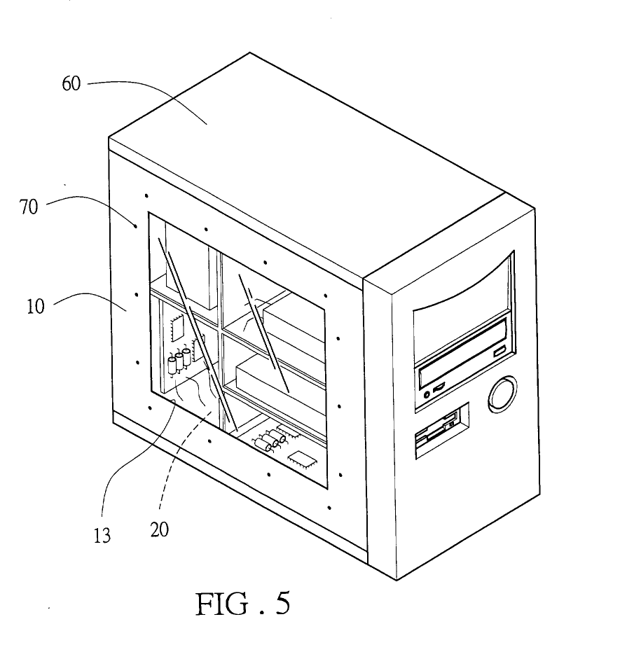

Referring to FIG. 1, FIG. 2 and FIG. 4, a transparent plate (20) with sculpture on sides for beauty purpose is fixed on the frame (10) with several compressing strip (30); the compressing strip (30) is in long rectangular shape and the cross section is in “Z” shape; one side of the compressing strip (30) is fixed with screw (70), the other side forms a holding slot (31) to hold the transparent plate (20) between the open window (13) of the frame (10) and the compressing strip (30), the transparent plate (20) is fixed firmly on the inner side of the open window (13) of the frame (10), referring to FIG. 5, users can see the internal device condition clearly through the transparent plate (20) for repairing and recording.

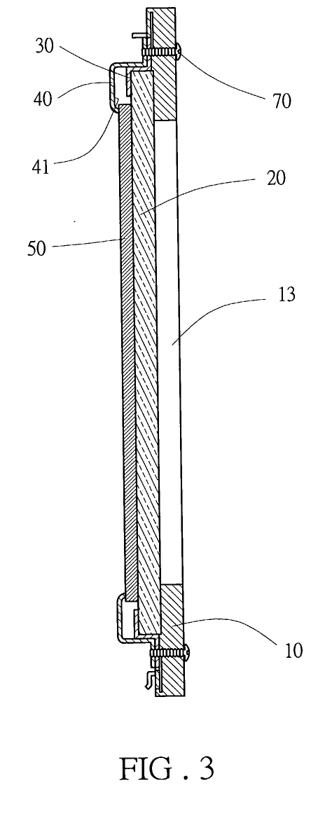

Another application of the present invention, referring to FIG. 1 and FIG. 3, a shielding plate (50) is fixed on the inner side of the frame (10) by several sealer (40); the sealer (40) is in strip shape and forms a curved fastener (41) in the center area, the curved fastener (41) is in “Ω” shape. One side of the sealer (40) is fixed firmly with a screw (70), the curved fastener (41) spans over the transparent plate (20), the other end of the sealer (40) covers the shielding plate (50) firmly to hide the internal devices for security purpose.

Based on above description, while repairing a computer, users can see the internal devices through the transparent plate (20) directly to make sure where the problem is or to record down the part specification first. A shielding plate (50) can also apply to cover the internal devices of a computer.

While a preferred embodiment of the invention has been shown and described in detail, it will be readily understood and appreciated that numerous omissions, changes and additions may be made without departing from the spirit and scope of the invention.

What is claimed is:

1. A sideboard of a computer enclosure comprising:
a frame with fasteners and inlaid plates on the edges of four sides to insert said fame firmly to a computer enclosure;
an open window in proper size is on said frame;
a transparent plate is fixed on said frame for users to see the internal devices of a computer.

2. The sideboard of a computer enclosure recited in claim 1, wherein said transparent plate has sculpture on sides for beauty purpose.

3. The sideboard of a computer enclosure recited in claim 1, wherein said transparent plate is fixed on said frame with several compressing strips, said compressing strip is in long rectangular shape and the cross section is in “Z” shape, one side of said compressing strip is fixed with screw, the other side forms a holding slot to hold said transparent plate between said open window of said frame and said compressing strip, said transparent plate is fixed firmly on the inner side of said open window.

4. The sideboard of a computer enclosure recited in claim 1, wherein a shielding plate is fixed on the inner side of said frame by several sealers, said sealer is in strip shape and forms a curved fastener in the center area, said curved fastener is in “Ω” shape, one side of said sealer is fixed firmly with a screw, said curved fastener spans over said transparent plate, the other end of said sealer covers said shielding plate firmly to hide the internal devices.
